(19) United States
(12) Patent Application Publication
(10) Pub. No.: US 2014/0251199 A1
(43) Pub. Date: Sep. 11, 2014

(54) JET-PUMP-BASED AUTONOMOUS UNDERWATER VEHICLE AND METHOD FOR COUPLING TO OCEAN BOTTOM DURING MARINE SEISMIC SURVEY

(71) Applicant: CGG SERVICES SA, Massy Cedex (FR)

(72) Inventor: Thierry BRIZARD, Massy (FR)

(73) Assignee: CGG SERVICES SA, Massy Cedex (FR)

(21) Appl. No.: 14/174,123

(22) Filed: Feb. 6, 2014

Related U.S. Application Data
(60) Provisional application No. 61/761,424, filed on Feb. 6, 2013.
(60) Provisional application No. 61/761,406, filed on Feb. 6, 2013.

(51) Int. Cl. B63G 8/39; G01V 1/24; B63G 8/08

(52) U.S. Cl. CPC B63G 8/39; B63G 8/08; G01V 1/24; B63G 2008/002
USPC 114/337

(57) ABSTRACT

An autonomous underwater vehicle (AUV) for recording seismic signals during a marine seismic survey. The AUV includes a body having a head part and a tail part); a propulsion system for guiding the AUV to a final target on the ocean bottom; a jet pump group connected to the body and including plural jet pumps; a control device connected to the jet pumps; and a seismic sensor configured to record seismic signals. The jet pump group controls a steering of the AUV by generating water jets according to a given sequence.

### BACKGROUND

1. Technical Field

Embodiments of the subject matter disclosed herein generally relate to methods and systems and, more particularly, to mechanisms and techniques for improving a coupling between the ocean bottom and an autonomous underwater vehicle (AUV) that carries seismic sensors for a marine seismic survey.

2. Discussion of the Background

Marine seismic data acquisition and processing generate a profile (image) of a geophysical structure under the seafloor. While this profile does not provide an accurate location of oil and gas reservoirs, it suggests, to those trained in the field, the presence or absence of these reservoirs. Thus, providing a high-resolution image of geophysical structures under the seafloor is an ongoing process.

Reflection seismology is a method of geophysical exploration to determine the properties of earth's subsurface, which is especially helpful in determining the above-noted reservoirs. Marine reflection seismology is based on using a controlled source of energy that sends the energy into the earth. By measuring the time it takes for the reflections and/or refractions to come back to plural receivers, it is possible to evaluate the depth of features causing such reflections. These features may be associated with subterranean hydrocarbon deposits.

A traditional system for generating seismic waves and recording their reflections off geological structures present in the subsurface includes a vessel that tows an array of seismic receivers provided on streamers. The streamers may be disposed horizontally, i.e., lying at a constant depth relative to the ocean surface, or they may have other than horizontal spatial arrangements. The vessel also tows a seismic source array configured to generate a seismic wave, which propagates downward and penetrates the seafloor until eventually a reflecting structure (reflector) reflects the seismic wave. The reflected seismic wave propagates upward until detected by the receiver(s) on the streamer(s). Based on the data collected by the receiver(s), an image of the subsurface is generated.

However, this traditional configuration is expensive because the cost of the streamers is high. Further, this configuration has its limitations when various obstacles (e.g., a rig) are present in the surveying area. New technologies deploy plural seismic sensors on the bottom of the ocean (ocean bottom stations) to improve the coupling. Even so, positioning seismic sensors remains a challenge.

Other technologies use permanent receivers set on the ocean bottom, as disclosed in U.S. Pat. No. 6,932,185, the entire content of which is incorporated herein by reference. In this case, the seismic sensors are attached to a heavy pedestal. A station that includes the sensors is launched from a vessel and arrives, due to its gravity, at a desired position and remains on the bottom of the ocean permanently. Data recorded by sensors is transferred through a cable to a mobile station. When necessary, the mobile station may be brought to the surface to retrieve the data.

Although this method provides a better coupling between the ocean bottom and the sensors, the method is still expensive and not flexible because the sensors and corresponding pedestals are left on the seafloor. Further, positioning the sensors is not straightforward.

An improved approach to these problems is the use of plural AUVs for carrying the seismic sensors and collecting the seismic data. The AUVs may be launched from a deployment vessel, guided to a final destination on the ocean bottom, instructed to record the seismic data, and then instructed to surface for collecting the seismic data. However, many challenges are posed in the deployment of AUVs for collecting seismic data, such as the coupling between the ocean bottom and the seismic sensor. The seismic sensor is currently located on the AUV's outer skin or in a chamber inside, so it is possible for the seismic sensor not to come in direct contact with the ocean bottom. Further, if the ocean bottom is hard, the AUV itself may not have good contact with it. If marine currents are present, the AUV may drift from its intended destination, which degrades the recorded seismic data.

Accordingly, it would be desirable to provide systems and methods that provide an inexpensive and simple way to achieve good coupling between the AUV's seismic sensors and the ocean bottom.

### SUMMARY

According to one exemplary embodiment, there is an autonomous underwater vehicle (AUV) for recording seismic signals during a marine seismic survey. The AUV includes a body having a head part and a tail part; a propulsion system for guiding the AUV to a final target on the ocean bottom; a jet pump group connected to the body and including plural jet pumps; a control device connected to the jet pumps; and a seismic sensor configured to record seismic signals. The jet pump group controls a steering of the AUV by generating water jets according to a given sequence.

According to another embodiment, there is a seismic survey system for collecting seismic data. The system includes plural autonomous underwater vehicle; a deployment vessel configured to deploy the plural AUVs in water; and a seismic source configured to generate seismic waves in the water. An AUV includes a body having a head part and a tail part, a propulsion system for guiding the AUV to a final target on the ocean bottom, a jet pump group connected to the body and including plural jet pumps, a control device connected to the jet pumps, and a seismic sensor configured to record seismic signals. The jet pump group controls the steering of the AUV by generating water jets according to a given sequence.

According to yet another embodiment, there is a method for recording seismic signals with an autonomous underwater vehicle (AUV). The method includes deploying the AUV in water, the AUV having a body with a head part and a tail part; driving the AUV with a propulsion system to a final target on the ocean bottom; steering the AUV during its journey to the final target with a jet pump group connected to the body and including plural jet pumps; and recording with a seismic sensor the seismic signals. The jet pump group steers the AUV by generating water jets according to a given sequence.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of an AUV;

FIG. 2 is a high-level view of an inside configuration of an AUV;

FIG. 3 is an inside view of an AUV;

FIG. 4 is an outside view of an AUV;

FIG. 5 is a schematic diagram of a steering system of an AUV according to an exemplary embodiment;

FIGS. 6A-E illustrate an anchoring motion achieved by an AUV according to an exemplary embodiment;

FIGS. 7A-B illustrate another anchoring method achieved by an AUV according to an exemplary embodiment;

FIGS. 8A-C schematically illustrate a jet pump group of an AUV according to an exemplary embodiment;

FIGS. 9A-B illustrate various steering actions associated with an AUV according to an exemplary embodiment;

FIGS. 10A-C schematically illustrate a jet pump group having three jet pumps according to an exemplary embodiment;

FIGS. 11A-C illustrate various implementations for attaching a jet pump group to an AUV according to an exemplary embodiment;

FIG. 12 illustrates a first implementation of a jet pump group to an AUV according to an exemplary embodiment;

FIG. 13 illustrates a second implementation of a jet pump group to an AUV according to an exemplary embodiment;

FIG. 14 illustrates a third implementation of a jet pump group to an AUV according to an exemplary embodiment;

FIG. 15 illustrates a fourth implementation of a jet pump group to an AUV according to an exemplary embodiment;

FIG. 16 is a flowchart of a method for replacing a jet pump group of an AUV according to an exemplary embodiment;

FIG. 17 is a schematic diagram of a control device that controls a jet pump group according to an exemplary embodiment; and

FIG. 18 is a schematic diagram of a seismic system that uses an AUV for collecting seismic data according to an exemplary embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of an AUV having one or more seismic sensors aboard and one or more vents for ejecting water. However, the embodiments to be discussed next are not limited to AUVs, but may be applied to other platforms (e.g., glider, buoy, etc.) that may carry seismic sensors.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Emerging technologies in marine seismic surveys need an inexpensive system for deploying and recovering seismic receivers at the ocean bottom. According to an exemplary embodiment, such a seismic system includes plural AUVs, each having one or more seismic sensors. The seismic sensors may be one of a hydrophone, geophone, accelerometers, electromagnetic sensors, etc. If an electromagnetic sensor is used, then a source that emits electromagnetic waves may be used instead of or in addition to an acoustic source.

The AUV may be a specially designed device or an off-the-shelf device so that it is inexpensive. The off-the-shelf device may be quickly retrofitted or modified to include seismic sensors and necessary communications means to be discussed later. The AUV may include, besides or in addition to a propulsion system, a buoyancy system. The buoyancy system may be a multi-phase system. A deployment vessel may store and launch AUVs as necessary for the seismic survey. After leaving the deployment vessel, the AUVs find their target positions using, for example, an inertial navigation system, or another means. Thus, the AUVs may be preprogrammed or partially programmed to find their target positions. If an AUV is partially programmed, the final detail for finding the target position may be received, e.g., acoustically, from the vessel when the AUV is launched from the vessel and/or while the AUV is navigating underwater. In the following, reference is made to a deployment vessel and/or a recovery vessel. Note that these vessels may be identical from an equipment standpoint. In one application, the deployment vessel is the same as the recovery vessel. Thus, when the document refers to a vessel, it might be the recovery vessel, the launching vessel or both of them. The deployment and/or recovery vessel may be a traditional vessel, or an underwater platform, connected or not to a surface vessel, or it may be an unmanned vessel that floats at the water's surface or underwater, etc.

As the deployment vessel is launching AUVs, a shooting vessel may cross the survey area to generate seismic waves. In one application, sources are provided on the deployment vessel or on other AUVs. The shooting vessel may tow one or more seismic source arrays. The seismic source array may include plural individual seismic sources that may be arranged on a horizontal, slanted or curved line underwater. The individual seismic source may be an air gun, a vibrational source or other known seismic sources. The shooting vessel or another vessel, e.g., the recovery vessel, may then instruct selected AUVs to resurface or to move underwater to a given location so they can be collected or they can dock with the recovery vessel. In one embodiment, the deployment vessel, if a traditional vessel, can also tow source arrays and shoot them as it deploys AUVs. In still another exemplary embodiment, only the deployment vessel is configured to retrieve AUVs. However, it is possible that only the shooting vessel is configured to retrieve AUVs. Alternatively, a dedicated recovery vessel may wake up AUVs and instruct them to return to the surface for recovery. In another application, AUVs are not launched from a vessel, but they may be stored on a docking station, e.g., floating underwater, or attached to a vessel or unmanned surface vessel, or other platform that is not a vessel.

In one exemplary embodiment, AUVs number in the thousands. Thus, the deployment vessel is configured to hold some or all of them at the beginning of the survey and then to launch them as the survey advances. If the deployment vessel is configured to hold only some AUVs, then more deployment vessels may be used to accommodate all AUVs. If the shooting vessel is configured to retrieve AUVs, when the number of available AUVs on the deployment vessel falls below a predetermined threshold, the shooting vessel and the deployment vessel are instructed to switch positions in mid-survey. If a dedicated recovery vessel is used to recover the AUVs, then the deployment vessel is configured to switch positions with the recovery vessel when the deployment vessel becomes empty. In another exemplary embodiment, both vessels are full of AUVs. The first one starts deploying AUVs, and the second one just follows the first one. Once the first one has deployed most or all of the AUVs, this vessel becomes the recovery vessel and the second one starts deploying AUVs, thus becoming the deployment vessel. Later, the two vessels may switch functions as necessary.

In an exemplary embodiment, the seismic survey is performed as a combination of AUV seismic sensors and streamer seismic sensors towed by the deployment vessel, the shooting vessel or both of them.

In still another exemplary embodiment, when selected AUVs are instructed to surface, they may be programmed to go to a desired rendezvous point to be collected by the shooting vessel, the deployment vessel or the recovery vessel. Alternatively, AUVs may be instructed to dock with a corresponding vessel as will be described later. The selected AUVs may belong to a given row or column if a row and column arrangement is used. The shooting and/or deployment or recovery vessel may be configured to send acoustic signals to the returning AUVs to guide them to the desired position. The AUVs may be configured to rise to a given altitude, execute the return path at that altitude, and then surface for recovery or dock underwater near the corresponding vessel. In one exemplary embodiment, AUVs are configured to communicate among themselves so they follow each other back to the recovery vessel, or they communicate among themselves to establish a queue in which to be retrieved by the shooting, recovery or deployment vessel.

Once on the vessel, AUVs may be checked for problems, their batteries may be recharged or replaced, and stored seismic data may be transferred to the vessel for processing. Alternatively or in addition, a compressed gas tank may be replaced or recharged for powering the AUV buoyancy system. The recovery vessel may store AUVs on deck during maintenance or somewhere inside the vessel, e.g., inside a module, closed or open, that is fixed on the vessel or the vessel's deck. A conveyor-type mechanism may be designed to recover AUVs on one side of the vessel when the vessel is used as a recovery vessel, and to launch AUVs from the other side of the vessel when the vessel is used for deployment. After maintenance, AUVs are redeployed as the seismic survey continues. Thus, in one exemplary embodiment, AUVs are continuously deployed and retrieved. In still another exemplary embodiment, AUVs are configured to not transmit the seismic data to the deployment, recovery or shooting vessel while performing the seismic survey. This may be advantageous when the electrical power available on the AUV is limited. In another exemplary embodiment, each AUV has enough electrical power (stored in the battery) to be deployed only once, record seismic data and resurface for retrieval. Thus, reducing data transmission volume between the AUV and the vessel while the AUV is underwater conserves power and allows the AUV to be retrieved on the vessel before running out of power. All the above embodiments may be adapted to not use traditional recovery and launching vessels, but rather other platforms, e.g., underwater platforms, unmanned vehicles, etc.

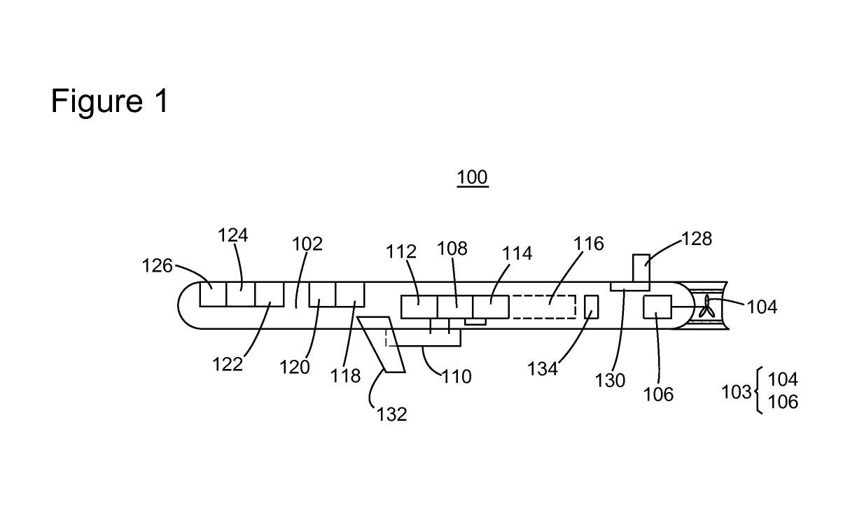

The above-noted embodiments are now discussed in more detail with regard to the figures. FIG. 1 illustrates an AUV 100 having a body 102 in which a propulsion system 103 may be located. Note that in one embodiment, there is no propulsion system. If propulsion system 103 is available, it may include one or more propellers 104 and a motor 106 for activating propeller 104. Alternatively, the propulsion system may include adjustable wings for controlling a trajectory of the AUV. Motor 106 may be controlled by a processor 108. Processor 108 may also be connected to a seismic sensor 110. Seismic sensor 110 may have a shape such that when the AUV lands on the seabed, the seismic sensor achieves a good coupling with the seabed sediment. The seismic sensor may include one or more of a hydrophone, geophone, accelerometer, etc. For example, if a 4C (four component) survey is desired, seismic sensor 110 includes three accelerometers and a hydrophone, i.e., a total of four sensors. Alternatively, the seismic sensor may include three geophones and a hydrophone. Of course, other sensor combinations are possible.

A memory unit 112 may be connected to processor 108 and/or seismic sensor 110 for storing seismic data recorded by seismic sensor 110. A battery 114 may be used to power all these components. Battery 114 may be allowed to shift position along a track 116 to change the AUV's center of gravity.

The AUV may also include an inertial navigation system (INS) 118 configured to guide the AUV to a desired location. An inertial navigation system includes at least a module containing accelerometers, gyroscopes or other motion-sensing devices. The INS is initially provided with the current position and velocity of the AUV from another source, for example, a human operator, a GPS satellite receiver, another INS from the vessel, etc., and thereafter, the INS computes its own updated position and velocity by integrating (and optionally filtrating) information received from its motion sensors. The advantage of an INS is that it requires no external references in order to determine its position, orientation or velocity once it has been initialized. Further, using an INS is inexpensive.

Besides or instead of INS 118, the AUV may include a compass 120 and other sensors 122 as, for example, an altimeter for measuring its altitude, a pressure gauge, an interrogator module, etc. AUV 100 may optionally include an obstacle avoidance system 124 and a communication device 126 (e.g., Wi-Fi or other wireless communication) or other data transfer device capable of wirelessly transferring seismic data. In one embodiment, the transfer of seismic data takes place while the AUV is on the vessel. Also, it is possible that communication device 126 is a port wire-connected to the vessel to transfer seismic data. One or more of these elements may be linked to processor 108. The AUV further includes an antenna 128 (which may be flush with the AUV's body) and a corresponding acoustic system 130 for communicating with the deploying, recovery or shooting vessel. Stabilizing fins and/or wings 132 for guiding the AUV to the desired position may be used with propulsion system 103 for steering the AUV. However, in one embodiment, the AUV has no fins or wings. The AUV may include a buoyancy system 134 for controlling the AUV's depth as will be discussed later.

The acoustic system 130 may be an Ultra-Short Baseline (USBL) system, also sometimes known as Super Short Base Line (SSBL), which uses a method of underwater acoustic positioning. A complete USBL system includes a transceiver mounted on a pole under a vessel, and a transponder/responder on the AUV. A processor is used to calculate a position from the ranges and bearings the transceiver measures. For example, an acoustic pulse is transmitted by the transceiver and detected by the subsea transponder, which replies with its own acoustic pulse. This return pulse is detected by the transceiver on the vessel. The time from transmission of the initial acoustic pulse until the reply is detected is measured by the USBL system and converted into a range. To calculate a subsea position, the USBL calculates both a range and an angle from the transceiver to the subsea AUV. Angles are measured by the transceiver, which contains an array of transducers. The transceiver head normally contains three or more transducers separated by a baseline of, e.g., 10 cm or less.

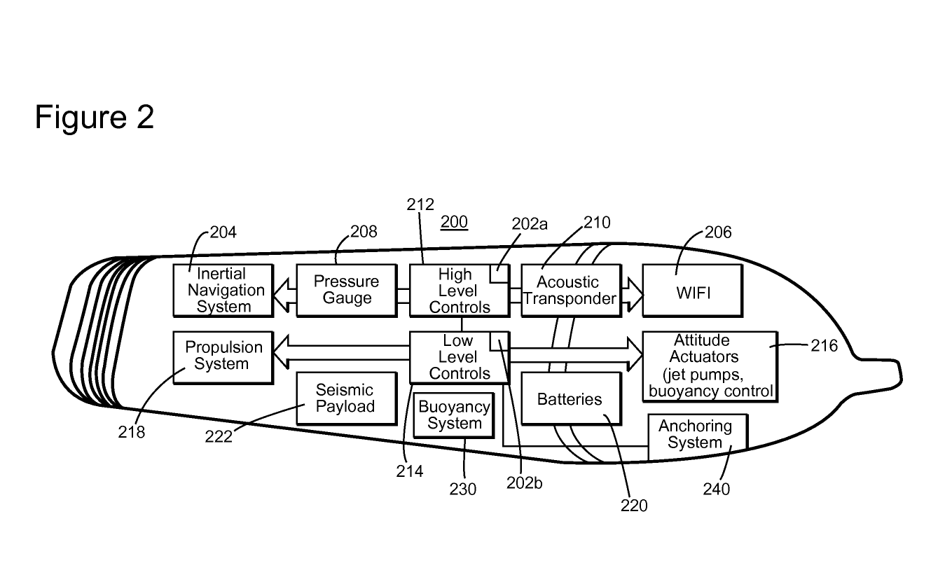

FIG. 2 is a high-level view of an AUV 200 that includes an anchoring mechanism 240 for improving a coupling with the ocean bottom. Besides the anchoring mechanism 240, AUV 200 may include a CPU 202a connected to INS 204 (or compass or altitude sensor and acoustic transmitter for receiving acoustic guidance from the deployment vessel), wireless interface 206, pressure gauge 208, and transponder 210. CPU 202a may be located in a high-level control block 212. The INS is advantageous when the AUV's trajectory has been changed, for example, because of an encounter with an unexpected object, e.g., fish, debris, etc., because the INS is capable of taking the AUV to the desired final position as it does for currents, wave motion, etc. Also, the INS may have high precision. For example, it is expected that for a target having a depth of 300 m, the INS and/or the acoustic guidance is capable of steering the AUV within +/−5 m of the desired target location. The INS may be configured to receive data from the vessel to increase its accuracy. In one application, the INS is replaced with another steering system. An optional CPU 202b, in addition to CPU 202a, is part of a low-level control module 214 configured to control attitude actuators 216 and the propulsion system 218. High-level control block 212 may communicate via a link with low-level control module 214 as shown in the figure. One or more batteries 220 may be located in AUV 200. A seismic payload 222 is located inside the AUV for recording seismic signals. A buoyancy system 230 that controls the AUV's buoyancy may also be located in AUV 200. Those skilled in the art would appreciate that more modules may be added to the AUV. For example, if a seismic sensor is outside the AUV's body, a skirt may be provided around or next to the sensor. A water pump may pump water from the skirt to create suction to achieve a good coupling between the sensor and the seabed. However, there are embodiments where no coupling with the seabed is desired. For those embodiments, no skirt is used.

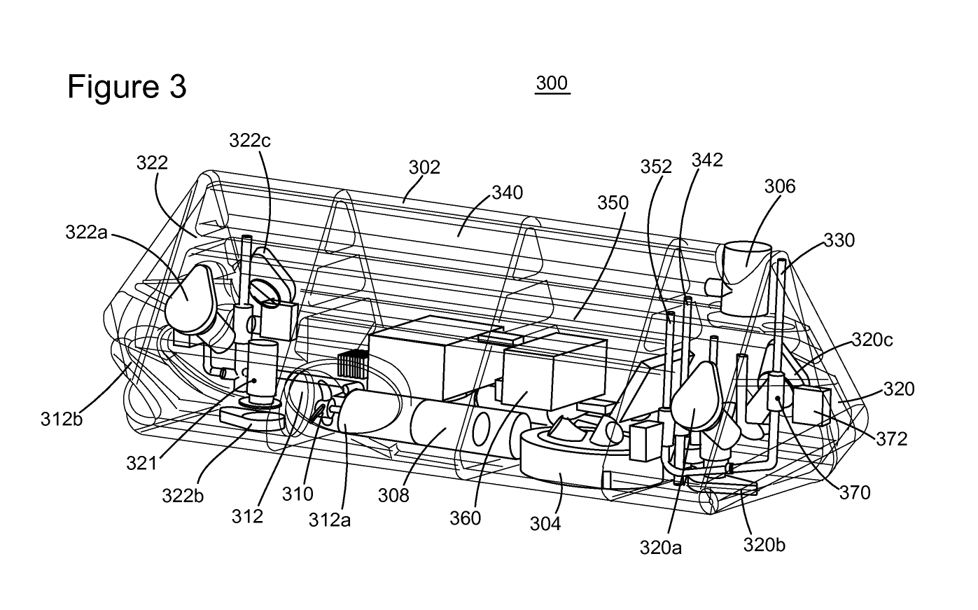

A more detailed structure of an AUV 300 having an anchoring mechanism is now discussed with reference to FIG. 3. AUV 300 has a body 302 that includes a payload 304 (e.g., seismic sensors) and an acoustic transceiver 306. In one embodiment, the acoustic transceiver may partially extend outside the body 302. Acoustic transceiver 306 is configured to communicate with the vessel and receive acoustic guidance while traveling toward a desired target point. Alternatively or additionally, an INS may be used for guidance. Many of the features discussed with regard to FIGS. 1 and 2 may be present in the body but, for simplicity, are neither shown nor discussed with regard to this figure.

FIG. 3 also shows a motor 308 configured to rotate a propeller 310 for providing thrust to AUV 300. One or more motors and corresponding propellers may be used. Alternatively, jet pumps may be used instead of motors. The entire motor 308 and propeller 310 may be within the body 302. Propeller 310 may receive water through a channel 312 in the body 302. Channel 312 has two openings, an intake water element 312a and a propulsion nozzle 312b that communicate with the ambient water. The two openings may be located on the head, tail or middle portions of the body 302.

Guidance nozzles may be provided at the head portion 320 and/or at the tail portion 322 of the body 302. Three guidance nozzles 320a-c may be located at the head portion 320, and three guidance nozzles 322a-c may be located at the tail portion 322 of the body 302. In one application, only the head portion nozzles are present. In still another application, only the tail portion nozzles are present. The nozzles are connected by piping to corresponding jet pumps 321. One or more jet pumps may be used to pump water through the nozzles. In one application, each nozzle is connected to a corresponding jet pump. Thus, each individual nozzle may be actuated independently. These jet pumps may take in water through various vents (e.g., 342, 352) and force the water through one or more of the guidance nozzles at desired speeds. Alternatively, the jet pumps may take in water at one guidance nozzle and expel water at the other nozzle or nozzles. Thus, according to this exemplary embodiment, the AUV has the capability to adjust the position of its nose with guidance nozzles 320a-c and the position of its tail with guidance nozzles 322a-c. However, in another embodiment, only tail nozzles or only nose nozzles are implemented.

By driving water out of the body 302, according to this exemplary embodiment, the AUV has the ability to adjust its head's position (with the guidance nozzles 320a-c) and its tail's position (with the guidance nozzles 322a-c). However, in other embodiments, only tail nozzles or only head nozzles may be implemented and/or controlled. In still another exemplary embodiment, a translation of the AUV may be controlled with guidance nozzles as will be discussed later. In yet another exemplary embodiment, a rotation of the AUV (yaw and pitch) may be controlled with guidance nozzles.

FIG. 3 also shows one or more chambers 340 and 350 that communicate through vents 330 with ambient water so the chambers may be flooded when desired. A control unit 360 may instruct a water pump to provide water into one or more of the chambers 340 and 350 (to partially or fully flood them) so that the AUV's buoyancy becomes neutral or negative. The same control unit 360 can instruct the water pump (or use another mechanism) to discharge water from the one or more chambers so that the AUV's buoyancy becomes positive. Alternatively, control unit 360 instructs one or more valves 370 to fluidly connect vent 330 to the flooding chamber for making the AUV's buoyancy negative. For making the buoyancy positive, control unit 360 may instruct accumulator 372 to provide compressed gas (e.g., air, CO₂, etc.) to the flooding chambers to expel water, and then valve 370 seals closed the emptied flooding chambers.

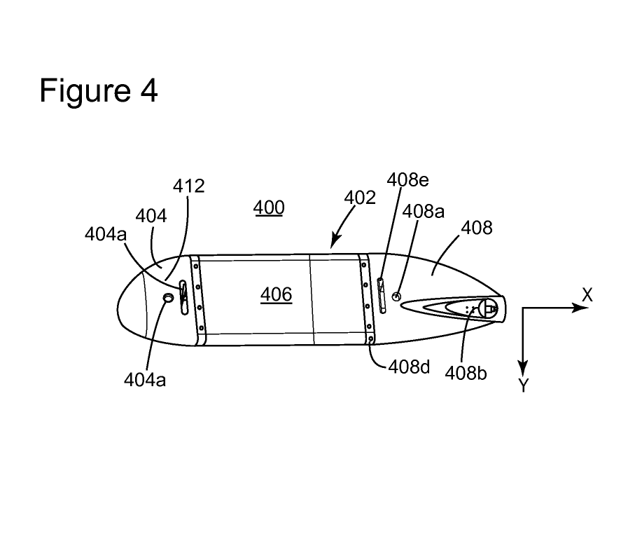

The nozzles and vents discussed above are illustrated in FIG. 4. AUV 400 has a body 402 that extends along a longitudinal axis X. The body 402 may include three parts, a head part 404, a middle part 406, and a tail part 408. These parts may be actual parts that are manufactured separately and then connected to each other or to a skeleton (not shown) of the AUV. However, in one application, these parts are not physically distinct, but are used to more easily describe the AUV's shape. Various nozzles 404a and 408a and slots 405a and 409a are shown on the body 402. The slots may be used as water intakes for one or more jet pumps, while the nozzles may be used as water outputs for the same jet pumps. Each face of the head and tail portions (in this embodiment, each portion has three faces) may have corresponding holes. In another application, each face of the head and tail portions may have corresponding slots. One or more engines 408b and associated propellers 408c may be provided on the tail part 408. In one embodiment, two engines and two propellers are on the body 402, and each engine may be controlled independently. However, in another embodiment, the engines and propellers are inside the body. Thus, in one exemplary embodiment, no component extends outside the body.

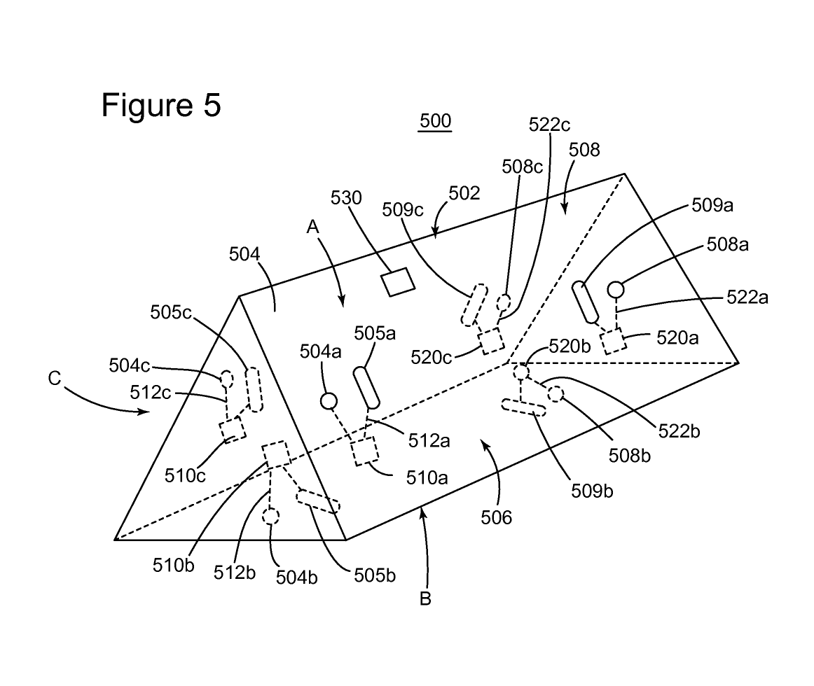

According to an exemplary embodiment illustrated in FIG. 5, an AUV 500 may have nozzles and slots on each face as now described. AUV 500 has a body 502 that is divided into a head part 504, a middle part 506, and a tail part 508. Each part has three faces A, B, and C. In another application, each part may have a different number of faces. For simplicity, each element associated with a face has a subindex corresponding to that face. For example, nozzle 504a is located on face A, nozzle 504b is located on face B and nozzle 504c is located on face C. Vent 505a is located on face A, vent 505b is located on face B and vent 505c is located on face C. All these nozzles and vents are located on the head part 504. Similar nozzles 508a-c and vents 509a-c are located on the three faces A-C on the tail part 508. Each nozzle is connected to a vent through a water pump. For example, nozzle 504a is fluidly connected to jet pump 510a through piping 512a, and jet pump 510a is also fluidly connected to vent 505a. The same is true for all nozzles and vents illustrated in the figure. Thus, this embodiment includes three jet pumps 510a-c in head part 504 and three jet pumps 520a-c in tail part 508. Appropriate piping 522a-c connects nozzles 508a-c and vents 509a-c to corresponding jet pumps 520a-c. A control device 530 may be connected to each jet pump and configured to individually control each of them.

With this configuration, AUV 500 may be programmed to anchor (couple) itself to the ocean bottom as now discussed. In this regard, anchoring system 240 discussed in FIG. 2 may include the nozzles, vents, piping and jet pumps illustrated in FIG. 5. Note that the illustrated AUV 500 is very schematic and many details are omitted for simplicity.

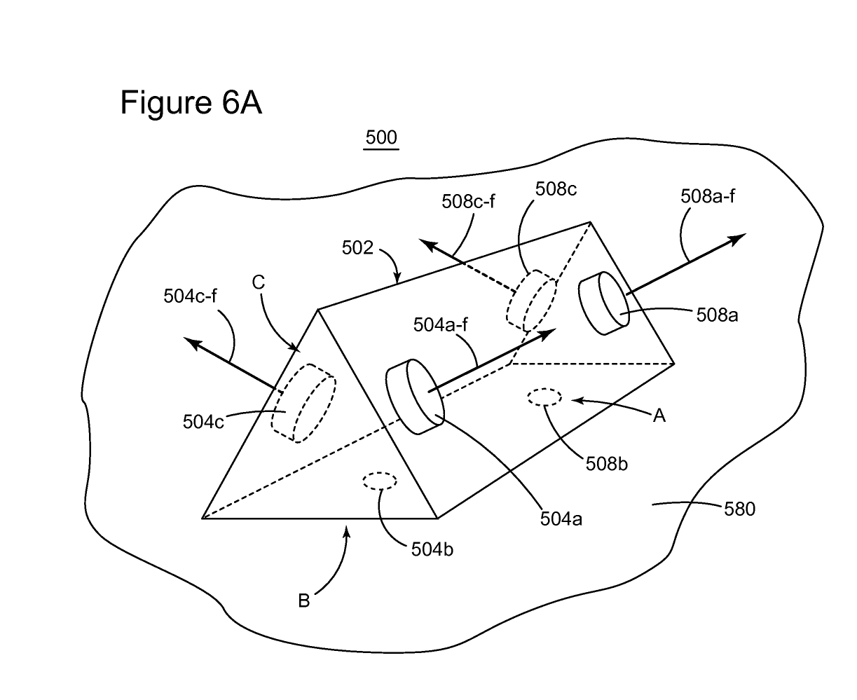

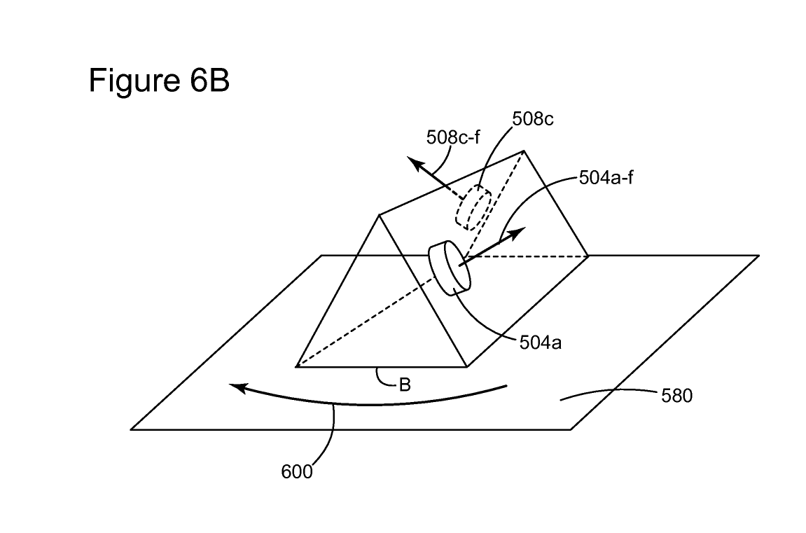

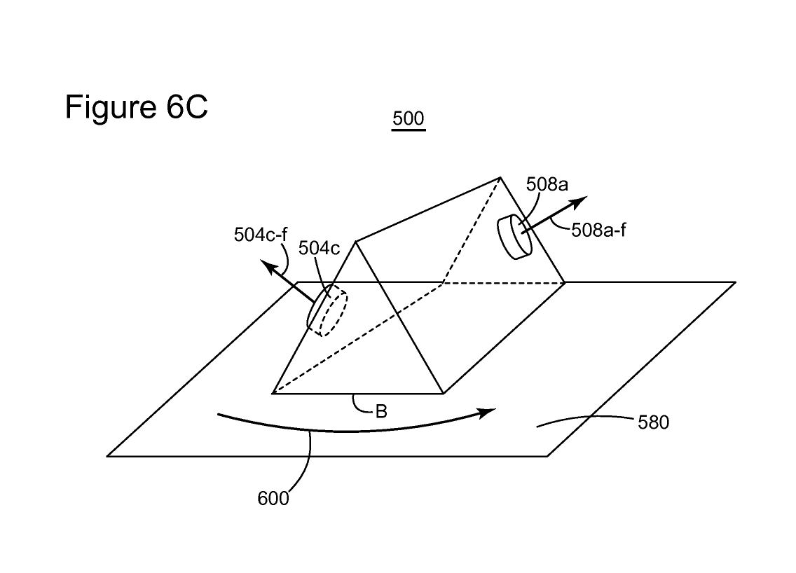

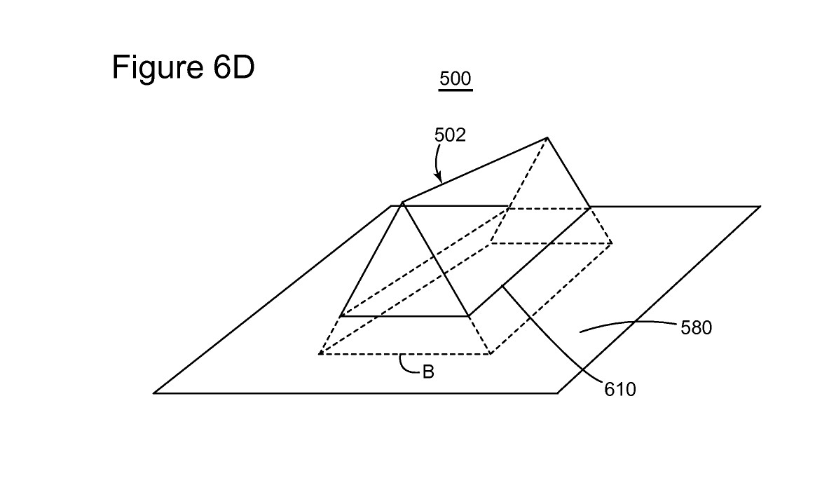

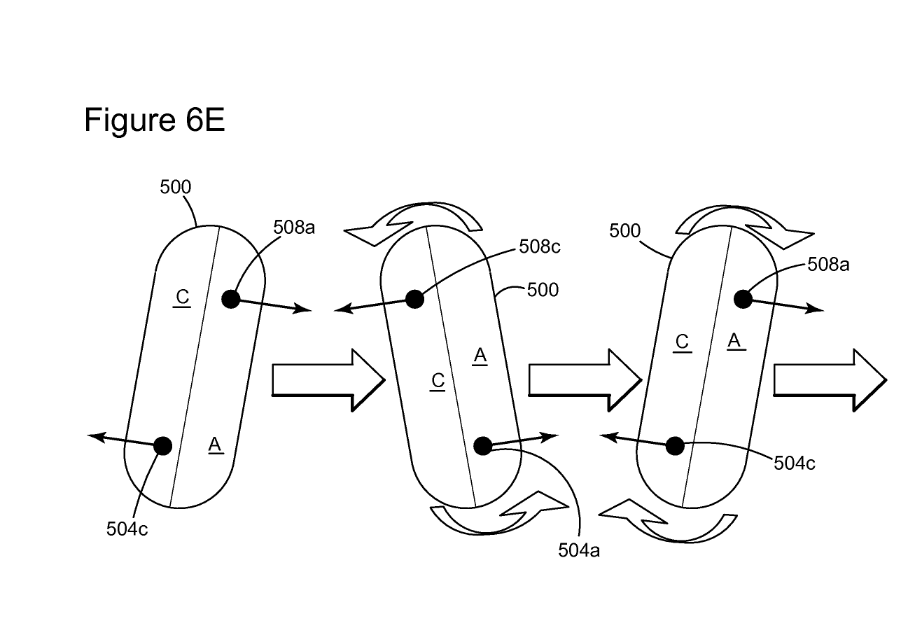

The anchoring method is now discussed with regard to FIGS. 6A-E. FIG. 6A shows AUV 500 and front nozzles 504a and 504c and tail nozzles 508a and 508c. These nozzles are located on sides A and C of AUV 500, and side B is considered to be the bottom side and in contact with the ocean bottom 580. FIG. 6A also shows directions 504a-F, 504c-F, 508a-F and 508c-F, along which the water is expelled from corresponding nozzles 504a, 504c, 508a and 508c. For this specific embodiment, head nozzle 504b and tail nozzle 508b are not used. After AUV 500 has landed on the ocean bottom 580, head nozzle 504a and tail nozzle 508c are activated, i.e., corresponding jet pumps 510a and 520c are activated by control device 530 for creating a torque that results in a rotational motion of the AUV along a first rotation direction 600 (see FIG. 6B, rotation of base face B relative to a vertical axis Z). The speed of the water jets and their time duration may vary from survey to survey. For example, a table may be stored in a storage memory of AUV 500 that takes into consideration the depth of the ocean bottom, and its consistency, i.e., stone, sand, mud, etc. At the beginning of the seismic survey, control device 530 may be programmed to select a speed and time duration for the jet pumps from the table.

Next, as illustrated in FIG. 6C, front nozzle 504c and tail nozzle 508a are activated to produce opposite water jets 504c-F and 508a-F. These opposite water jets create a torque that makes AUV 500 rotate along a second rotation direction 602. Note that during each step, a head nozzle and a tail nozzle on opposite sides of the AUV are activated to create the torque that partially rotates the AUV, thus, contributing to anchoring the AUV to the ocean floor. The result of these alternate steps of partially rotating the AUV are shown in FIG. 6D, i.e., note that AUV 500 has partially burrowed into the ocean floor 580 (face B is shown buried and lateral faces A and C are partially buried up to a level 610). This burying or anchoring action of the AUV improves the coupling of the AUV and/or sensor with the ocean bottom and also stabilizes the AUV when there are strong currents on the ocean bottom, which under normal circumstances will make the AUV drift.

The above-described partial rotational motion is schematically shown in FIG. 6E, which is a top view of AUV 500, and shows alternatively performing a twisting motion (partial rotation) for anchoring the AUV to the ocean floor. In other words, the head and tail nozzles are activated according to a given sequence (as illustrated in FIGS. 6B-D) for achieving the twisting motion. The given sequence may be repeated a predetermined number of times or for a set time.

In one application, the head and tail nozzles of the bottom face B may also be used, simultaneously with nozzles 504a, 504c, 508a and 508c, for different reasons. For example, if the ocean bottom is known to be muddy or sandy, water jets may be pumped at slow speeds through bottom nozzles 504b and 508b to fluidize the floor while the side nozzles are used as described above to impart the twisting motion. For that purpose, the jet pumps may be run at different speeds, for example, a first low speed to fluidize the ocean bottom and a second high speed for the twisting motion. In still another application, when the time to detach the AUV from the ocean bottom has come, bottom nozzles 504b and 508b may be used at the second high speed to move the AUV away from the ocean bottom.

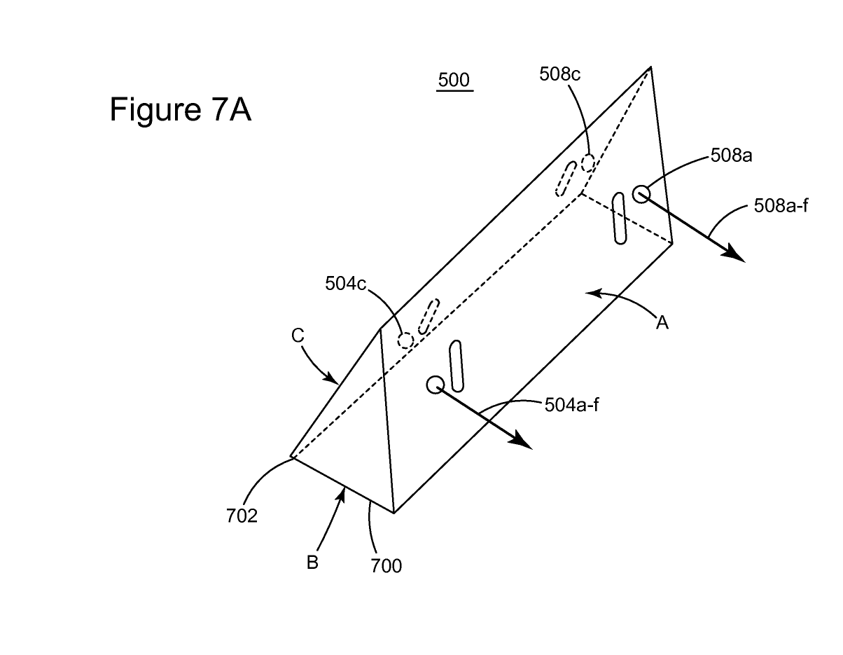

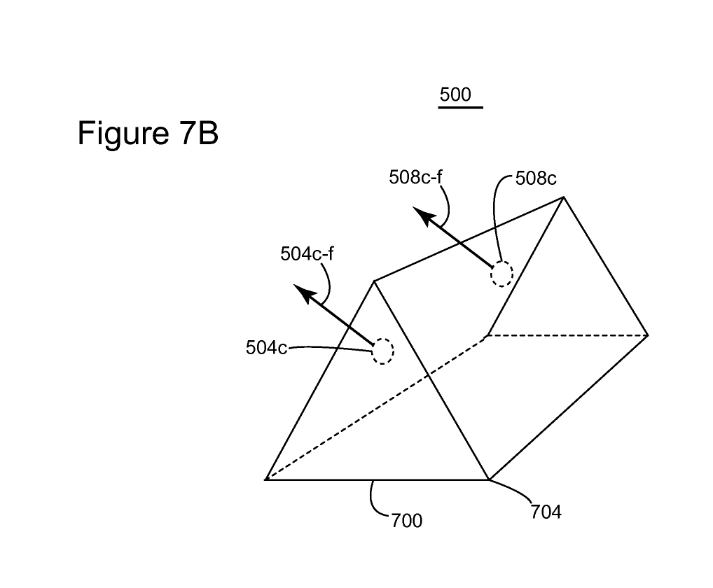

According to another embodiment illustrated in FIGS. 7A-B, control device 530 (shown in FIG. 5) may be configured to actuate the jet pumps in a different way to achieve the anchoring. As shown in FIG. 7A, the control device actuates jet pumps 510a and 520a (shown in FIG. 5) simultaneously so that water jets 504a-F and 508a-F generated by nozzles 504a and 508a are produced on the same side A of AUV 500. These simultaneous forces applied on the same face of the AUV cause a side 700 of the AUV to pivot around a point 702. Then, the opposite nozzles 504c and 508c are activated to produce water jets 504c-F and 508c-F as shown in FIG. 7B. This causes side 700 of the AUV to pivot around a point 704. Repeating these steps to achieve this rocking motion causes the AUV to anchor itself to the ocean bottom.

According to another exemplary embodiment, the twisting motion illustrated in FIGS. 6A-E may be combined with the rocking motion illustrated in FIGS. 7A-B as discussed next. In one application, after each twisting motion, a rocking motion is applied. In another application, a number “n” of twisting motions are performed before applying a number “m” of rocking motions. Numbers n and m may be one or larger.

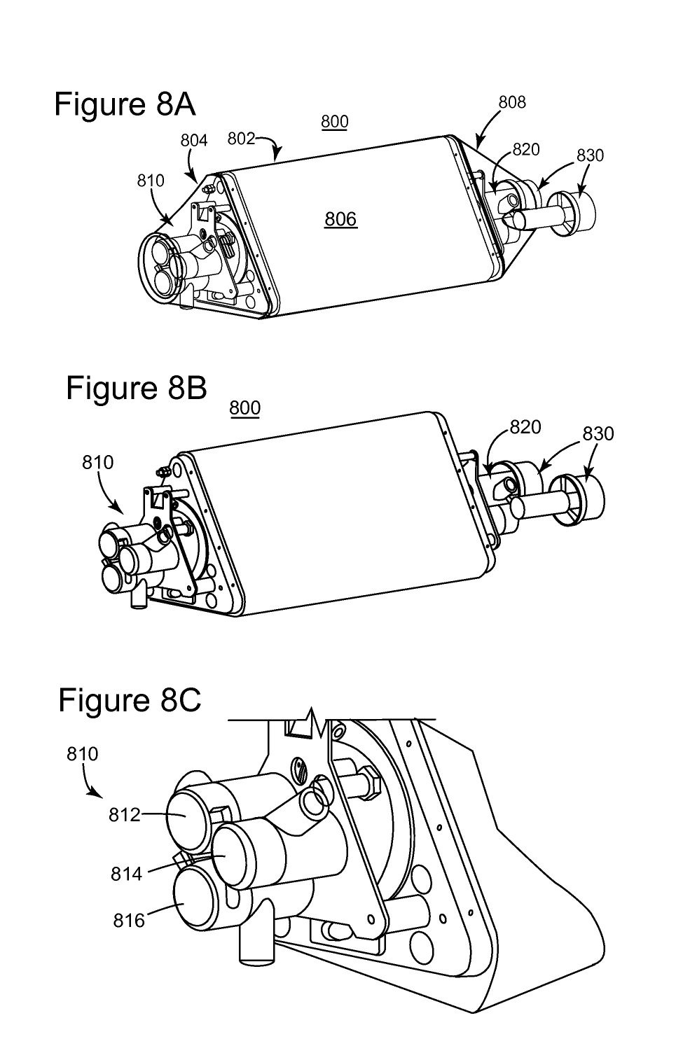

Next, the configuration of the jet pumps and how they are attached to the frame of the AUV are discussed. FIG. 8A shows an AUV 800 having a body 802 that includes a head part 804, a middle part 806 and a tail part 808. A head jet pump group 810 is attached to head part 804 and a tail jet pump group 820 is attached to tail part 808. FIG. 8A also shows a propulsion system 830 that helps to propel the AUV toward a desired target location. The head and tail jet pump groups 810 and 820 are also illustrated in FIG. 8B. FIG. 8C shows a detailed view of the head jet pump group 810. According to this exemplary embodiment, the head jet pump group 810 includes three independently controlled jet pumps 812, 814 and 816.

Having this jet pump configuration, the AUV is capable of achieving a variety of functions when deployed underwater. For example, as illustrated in FIGS. 6A-E, activating the jet pumps in a given sequence results in a twisting motion of the AUV, which may be used, for example, to anchor the AUV to the ocean bottom. As further illustrated in FIGS. 7A-B, the jet pumps may be activated in another sequence to achieve a rocking motion. Also, it is possible to activate only the base nozzles to help the AUV take off, i.e., to detach from the ocean bottom.

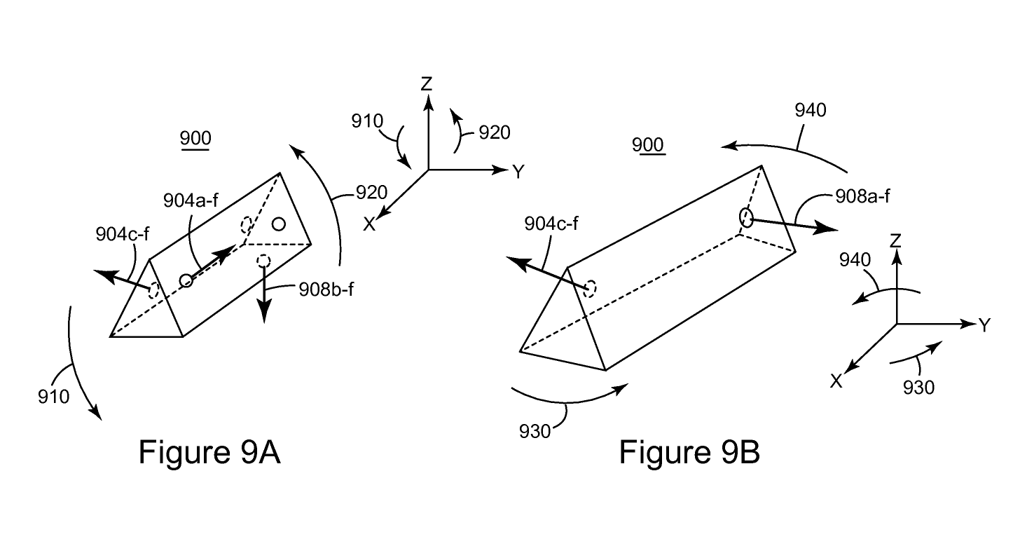

Furthermore, as illustrated in FIGS. 9A-B, the jet pumps may be activated to steer the AUV while traveling underwater. FIG. 9A shows a sequence that promotes vertical steering. If water jets 904a-F and 904c-F are generated at the head part, on the lateral faces of the AUV and, simultaneously, a water jet is generated at the tail part, on the base face, the head of the AUV will move downward along direction 910, and the tail will move upward along direction 920, i.e., in a vertical plane. If lateral steering is desired, then, as illustrated in FIG. 9B, water jet 904c-F is generated at the head part and water jet 908a-F is generated at the tail part to rotate the head along direction 930 and the tail along direction 940, thus resulting in lateral steering. In both FIGS. 9A and 9B, fewer water jets may be used to achieve vertical and/or lateral steering.

According to an exemplary embodiment, the jet pump groups need to satisfy certain requirements. For example, the jet pump groups need to fit into a certain space available in the head and/or tail parts of the AUV. The jet pump groups need to withstand the hardship imposed by seawater, e.g., salinity, mud, sand, etc. Another requirement imposed on jet pump groups is to produce limited noise because this noise may interfere with the seismic sensors on board the AUV, thus, polluting the recorded seismic data.

Another feature to be considered when designing jet pump groups and attaching them to the AUV's frame is the water pressure at the ocean bottom (which can be quite great) and the sealing interface between the jet pump groups and the dry interior of the AUV housing its electronics and other components. Various configurations are discussed next for attaching jet pump groups to the AUV body.

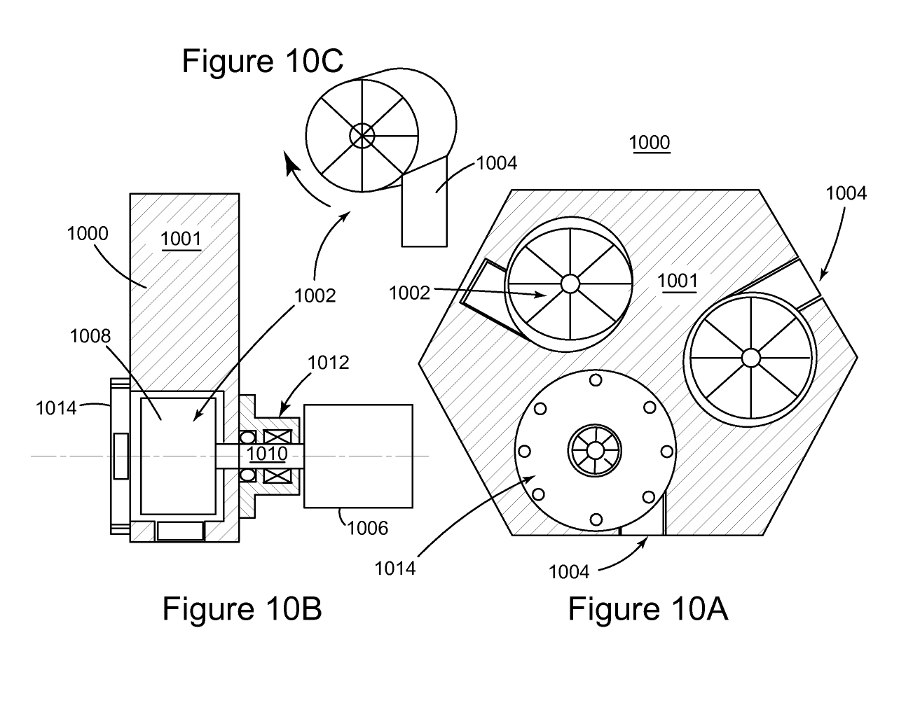

FIGS. 10A-C schematically illustrate a jet pump group 1000. FIG. 10A is a front view of jet pump group 1000, with a jet pump block 1001 in which are located three jet pumps 1002. FIG. 10B is a cross-sectional view of the jet pump block illustrating how a jet pump is attached to the jet pump group. Each jet pump has an exhaust (nozzle) 1004 (see FIG. 10C) located on the AUV's skin, and may include a motor 1006 that rotates a corresponding (axial) turbine 1008. The turbine 1008 is connected through a shaft 1010 to the corresponding motor 1006. Bearings 1012 may be located around the shaft 1010. Each turbine 1008 may be covered by a turbine cover 1014.

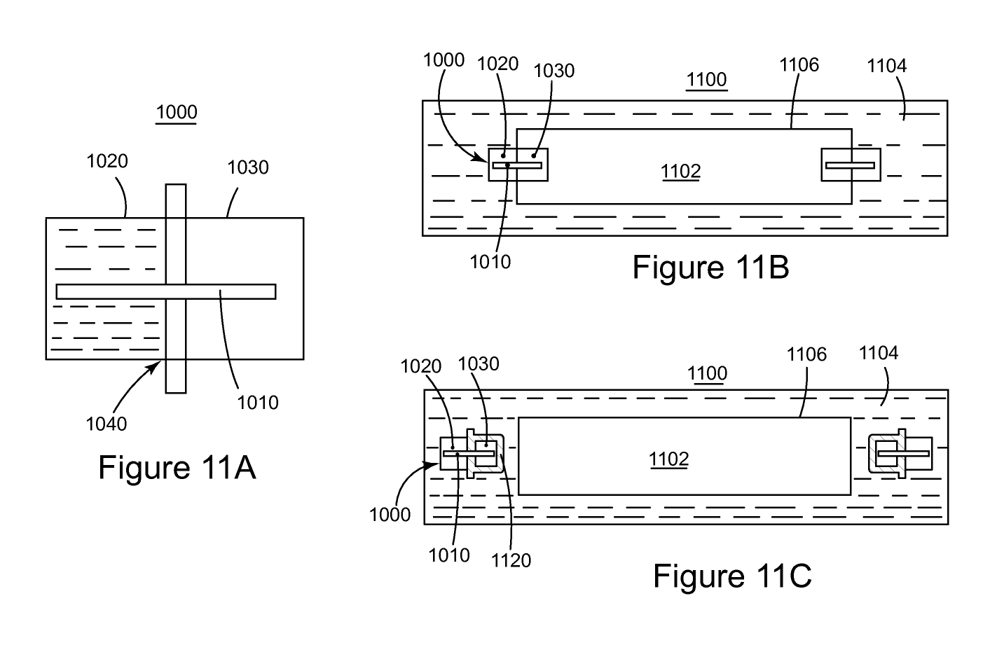

Each jet pump 1002 may include, as illustrated in FIG. 11A, a wet part (e.g., the turbine) 1020 and a dry part (e.g., the motor) 1030. The motor shaft 1010 extends into both wet part 1020 and dry part 1030. A sealing system 1040 fluidly insulates the wet part from the dry part, i.e., prevents water from the wet part to enter the dry part. In this regard, FIG. 11B shows an AUV 1100 having a dry interior 1102 and water 1104 around its body 1106. A jet pump group 1000 is mounted, in FIG. 11B, so that its dry part 1030 is shared with the dry interior 1102 of the AUV. FIG. 11C shows a different application in which the dry part 1030 of the jet pump group 1000 is separated from the dry interior 1102 of the AUV by a pump carter 1120. The two embodiments illustrated in FIGS. 11B and 11C are now discussed in more detail.

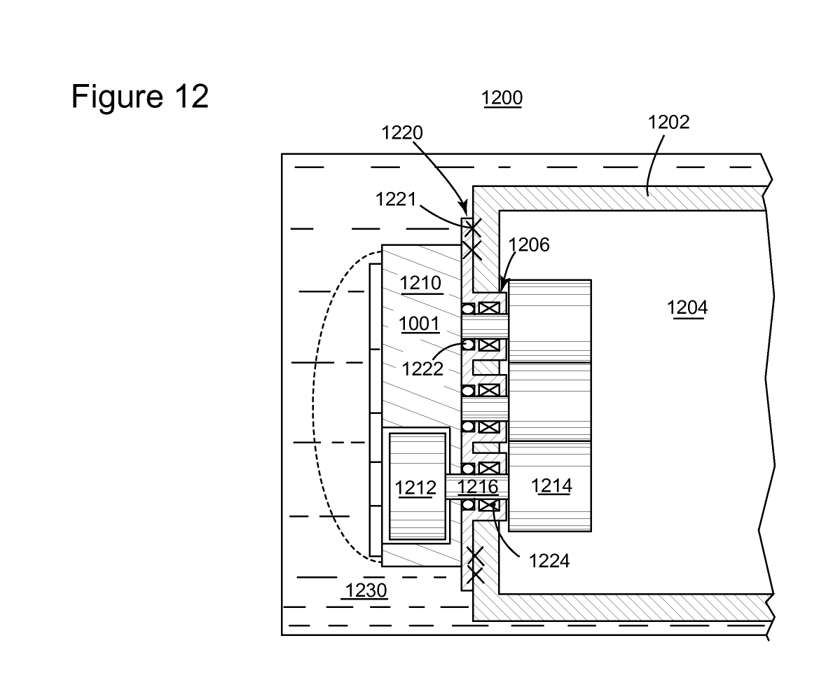

FIG. 12 illustrates the first possibility, i.e., the dry part of the jet pump group is located inside the dry part of the AUV, and there is no sealing between the two dry parts. More specifically, FIG. 12 shows an AUV 1200 having a body 1202. The body 1202 has a dry part 1204, inside the AUV, that houses various electronic components. The jet pump group 1210 has multiple jet pumps, one jet pump including a turbine 1212, a motor 1214 and a shaft 1216 that connects the turbine to the motor. Electric motor 1214 of jet pump group 1210 is located in dry part 1204 of the AUV. A sealing plate 1220 is located between motors 1214 and corresponding turbines 1212. In one application, a hole 1206 formed in the frontal part of the body 1202 is sealed from the ambient 1230 by sealing plate 1220. Shafts 1216 extend through sealing plate 1220. In one application, sealing rings 1222 and bearings 1224 may be located around shaft 1216, outside body 1202 and sealing plate 1220. Sealing elements 1221 may be placed between sealing plate 1220 and body 1202 to prevent water entering dry part 1204.

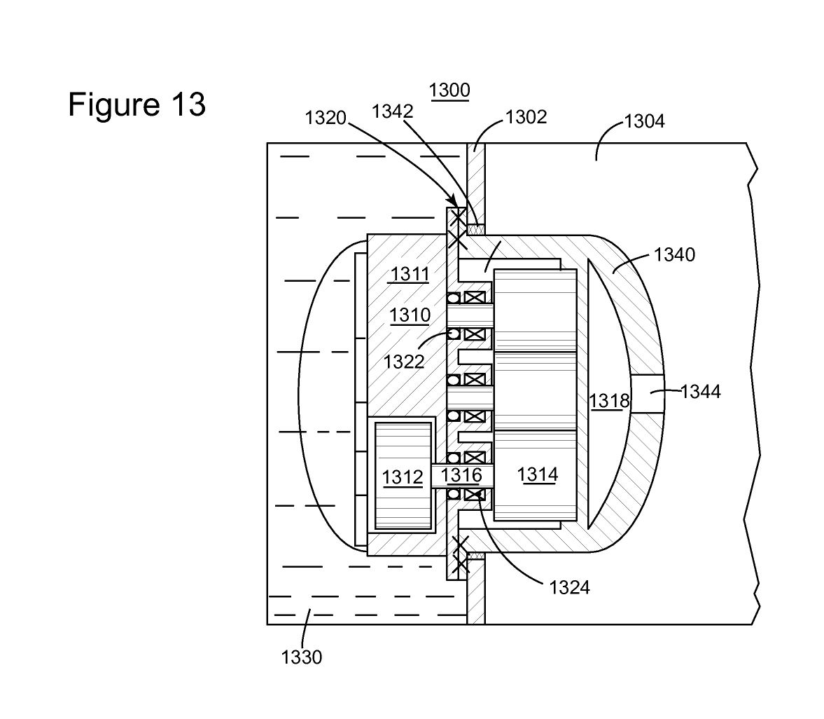

FIG. 13 illustrates an alternative configuration in which the entire jet pump group is placed outside the dry part of the AUV's body. More specifically, AUV 1300 has a body 1302 that defines an interior dry part 1304 in which the electronics (not shown) are located. Jet pump group 1310 does not share dry part 1304 of the AUV. Jet pump group 1310 has its motors 1314 located in its own dry part 1318. Dry part 1318 is achieved by attaching a pump carter 1340 to jet pump block 1311. In this configuration, the turbines 1312 are located within jet pump block 1311, in wet part 1330. Sealing plate 1320 and sealing rings 1324 may be used to separate wet part 1330 from dry part 1318 of the jet pump group. Sealing rings 1342 may be used to fluidly insulate dry part 1304 of the AUV from wet part 1330. Further sealings (not shown) may be located between pump carter 1340 and sealing plate 1320. Electric cables that connect the jet pump group's motors to a power source may enter the AUV's dry part 1304 through a hole 1344.

In this embodiment, the jet pump group may be attached, as a single unit, to the frame of the AUV as necessary. For example, if one of the jet pumps stops working, the entire jet pump group may be removed from the AUV's frame and replaced with a new unit, minimizing repair time. For this reason, the jet pump group may be attached with screws or other quick-release mechanisms to the AUV's frame.

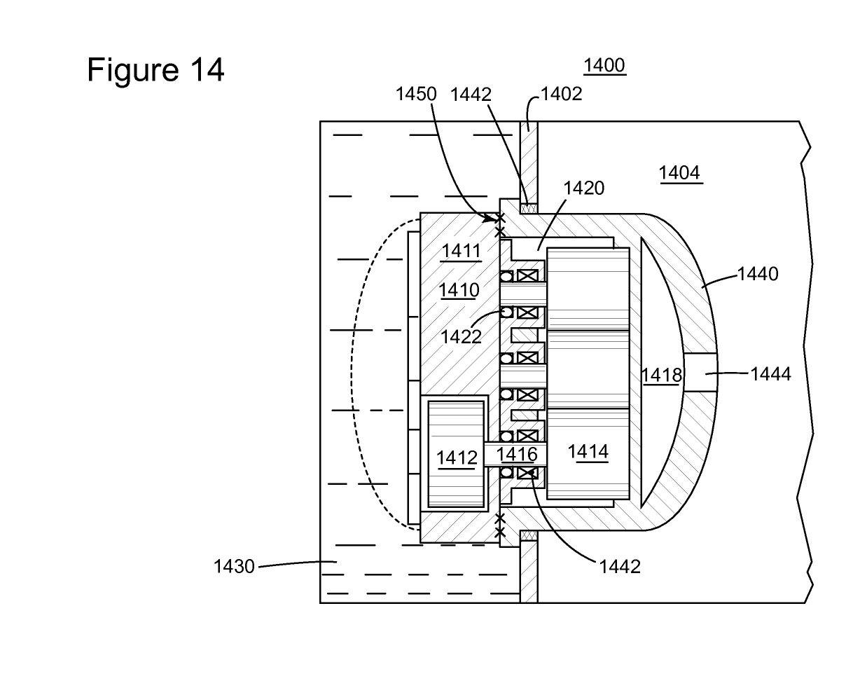

An alternative embodiment is illustrated in FIG. 14. AUV 1400 is similar to AUV 1300 shown in FIG. 13 except that sealing plate 1420 is now inside the cavity formed by the turbine block 1411 and the pump carter 1440. Thus, a sealing member 1450 may be located between turbine block 1411 and pump carter 1440 to prevent water entering the jet pump group's dry part 1418. A sealing component 1442 may be located between the body 1402 and pump carter 1440 for preventing water to enter dry part 1404 of the AUV.

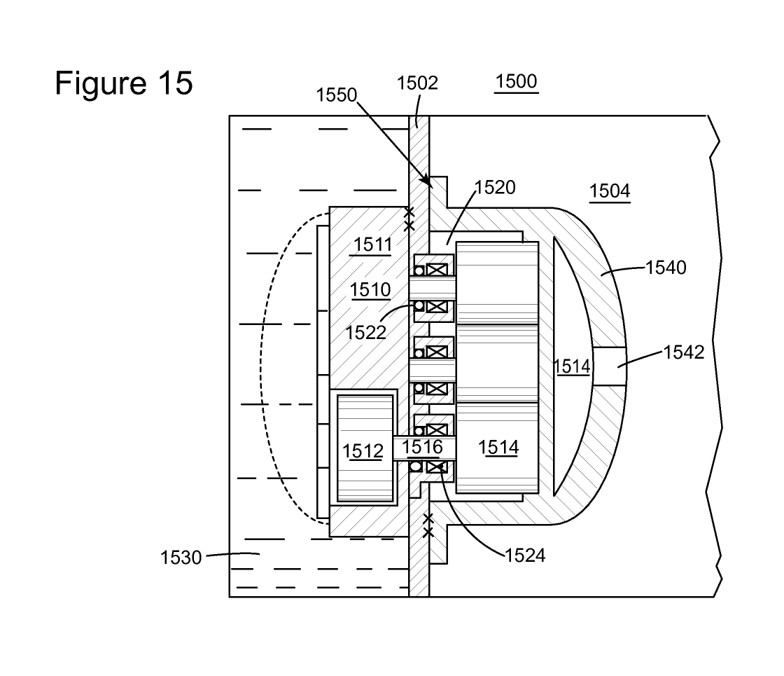

Another alternative embodiment is illustrated in FIG. 15, in which the pump carter 1540 is located, in its entirety, inside the AUV's body 1502. Seals 1550 are located between the body 1502 and pump carter 1540 to prevent water entering dry part 1504. Sealing plate 1520 may be located in contact with the body 1502 to prevent water entering the jet pump block's dry part 1514.

The shape of the AUV may vary. According to an exemplary embodiment, the AUV has three faces, a base face and two side faces. In one application, the middle part of the body has a triangular-like cross-section. For this shape, the jet pump block has three jet pumps symmetrically distributed along a longitudinal axis of the AUV. Thus, each jet pump has a nozzle on a face of the AUV.

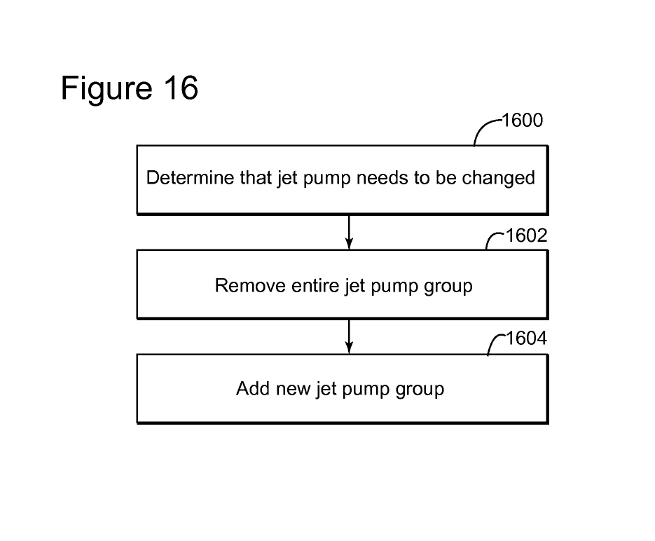

For any of the above configurations, there is a method for changing a jet pump group in case a jet pump becomes defective. According to this method illustrated in FIG. 16, there is a step 1600 of determining that a jet pump needs to be replaced. In step 1602, the corresponding jet pump group is replaced from its location in the AUV, either head or tail, and in step 1604 a new jet pump group is attached to the AUV's frame. In one application, the jet pump group includes three jet pumps connected to each other through the jet pump block.

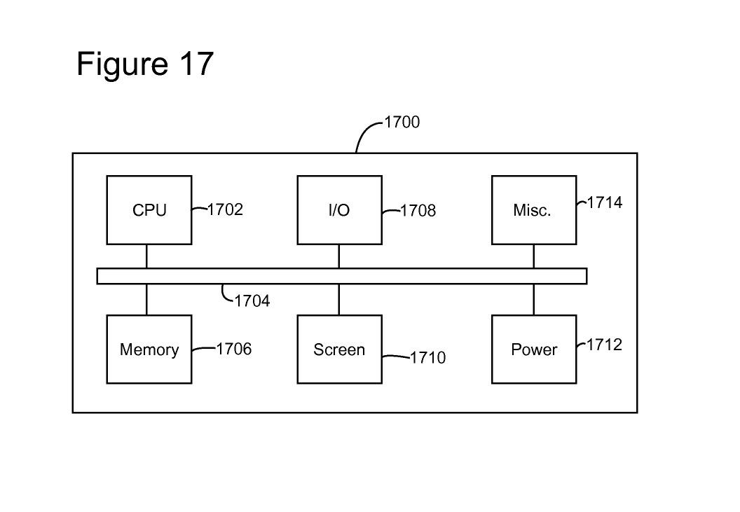

FIG. 17 schematically illustrates an internal configuration of a control device 1700, which corresponds, for example, to control device 530 used in one or more of the above-discussed embodiments. Control device 1700 may include a processor 1702 connected to a bus 1704. Processor 1702 is configured to execute commands stored, for example, in a storage device 1706. Based on these commands, processor 1702 activates corresponding jet pumps to achieve a desired activation sequence. Control device 1700 may include an input/output interface 1708, also connected to bus 1704, and through which an operator may interact with the control device. Input/output interface 1708 may be also used by the AUV to directly communicate with a corresponding interface on the deployment/recovery vessel. For example, diagnostic messages, seismic data or quality data may be exchanged through this interface. Control device 1700 may optionally include a screen 1710, a power source 1712 and other components 1714 as will be recognized by those skilled in the art.

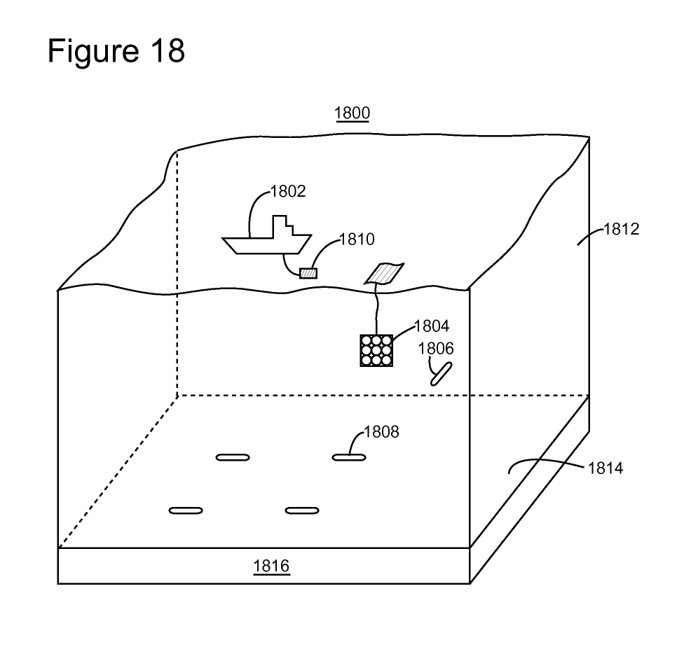

FIG. 18 shows a seismic system 1800 for collecting seismic data. The system 1800 has at least one vessel (surface ship 1802 and/or floating platform 1804) configured to deploy AUVs and/or communicate with them. An AUV 1806 is shown traveling in a volume of water 1812 toward a final destination on the ocean bottom 1814. Plural AUVs 1808 may be already deployed on the ocean bottom 1814. A seismic source 1810, attached to deployment vessel 1802 or to a source vessel (not shown) generates seismic waves, which are recorded, after being reflected by the subsurface 1816, by the seismic sensors located on AUVs 1808.

One or more of the exemplary embodiments discussed above disclose an AUV having one or more jet pump groups that perform various steering and anchoring functions associated with performing seismic recordings. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. An autonomous underwater vehicle (AUV) for recording seismic signals during a marine seismic survey, the AUV comprising:
a body having a head part and a tail part;
a propulsion system for guiding the AUV to a final target on the ocean bottom;
a jet pump group connected to the body and including plural jet pumps;
a control device connected to the jet pumps; and
a seismic sensor configured to record seismic signals,
wherein the jet pump group controls a steering of the AUV by generating water jets according to a given sequence.

2. The AUV of claim 1, wherein the jet pump group comprises:
a jet pump block configured to accommodate jet pumps, their turbines, and to provide water ingress to the turbines along an axis of the pumps, and to guide a flow of the pumps.

3. The AUV of claim 2, wherein each jet pump comprises:
a motor;
a turbine located within the jet pump block; and
a shaft connecting the motor to the turbine.

4. The AUV of claim 3, wherein the motor is located inside a dry part of the body of the AUV.

5. The AUV of claim 4, further comprising:
a sealing plate located between the jet pump block and the body of the AUV for preventing water entering the dry part of the AUV; and
a sealing element located between sealing plate and body.

6. The AUV of claim 3, wherein the motor is located within a dry part formed between a pump carter and a sealing plate, but outside a dry part of the AUV.

7. The AUV of claim 6, wherein the pump carter seals a hole formed in the body of the AUV and the pump carter extends into the dry part of the AUV.

8. The AUV of claim 7, further comprising:
a sealing plate located between the jet pump block and the pump carter and configured to prevent water entering in the dry part of the jet pump group.

9. The AUV of claim 7, further comprising:
a sealing plate located inside the dry part and configured to protect the motor from being contacted by water.

10. The AUV of claim 7, wherein the pump carter is attached to an inside of the body of the AUV and the jet pump block is attached to an outside of the body.

11. The AUV of claim 7, wherein the pump carter is attached to an outside of the body of the AUV and the jet pump block is also attached to the outside of the body.

12. The AUV of claim 1, wherein the plural jet pumps are distributed symmetrically around a longitudinal axis of the AUV.

13. The AUV of claim 1, wherein the jet pump group is removably attached to the head part of the body and another jet pump group is removably attached to the tail part of the of the body.

14. The AUV of claim 13, wherein each jet pump group has three jet pumps independently controlled.

15. A seismic survey system for collecting seismic data, the system comprising:
plural autonomous underwater vehicle (AUV);
a deployment vessel configured to deploy the plural AUVs in water; and
a seismic source configured to generate seismic waves in the water,
wherein an AUV comprises,
a body having a head part and a tail part,
a propulsion system for guiding the AUV to a final target on the ocean bottom,
a jet pump group connected to the body and including plural jet pumps,
a control device connected to the jet pumps, and
a seismic sensor configured to record seismic signals,
wherein the jet pump group controls the steering of the AUV by generating water jets according to a given sequence.

16. A method for recording seismic signals with an autonomous underwater vehicle (AUV), the method comprising:
deploying the AUV in water, the AUV having a body with a head part and a tail part;
driving the AUV with a propulsion system to a final target on the ocean bottom;
steering the AUV during its journey to the final target with a jet pump group connected to the body and including plural jet pumps; and
recording with a seismic sensor the seismic signals,
wherein the jet pump group steers the AUV by generating water jets according to a given sequence.

17. The method of claim 16, wherein the jet pump group is removably attached to the head of the body and another jet pump group is removably attached to the tail of the of the body.

18. The method of claim 17, wherein each jet pump group has three or more jet pumps that are independently controlled.

19. The method of claim 17, further comprising:
replacing the jet pump group with a replacement jet pump group.

20. The method of claim 16, wherein the jet pump group is configured to steer the AUV during its journey, to anchor the AUV to the ocean bottom, and to detach the AUV from the ocean bottom by executing corresponding sequences of activating the plural jet pumps.
